(19) United States
(12) Patent Application Publication
(10) Pub. No.: US 2018/0189834 A1
(43) Pub. Date: Jul. 5, 2018

(54) METHOD AND SYSTEM FOR IDENTIFYING AN OPTIMAL PROMOTION-TYPE FOR PRODUCTS

(71) Applicant: Wipro Limited, Bangalore (IN)

(72) Inventors: Sameer Singh Deo, Bangalore (IN); Unmesh Mokashi, Mumbai (IN); Sujit Singh, Hyderabad (IN); Amit Vikram, Bangalore (IN)

(21) Appl. No.: 15/438,255

(22) Filed: Feb. 21, 2017

(30) Foreign Application Priority Data
Jan. 3, 2017 (IN) 201741000235

(51) Int. Cl. G06Q 30/02

(52) U.S. Cl. CPC G06Q 30/0259; G06Q 30/0249; G06Q 30/0246

(57) ABSTRACT

Systems and methods for identifying optimal promotion-types for plurality of products are described. The system may consider various factors like time, location, non-promotional scenario, promotional scenario and user-defined constraints for computing different values like total sales, total loss, total cost, total profit and profitability ratio. These values may be computed in both non-promotional and promotional scenarios. Further, the system may compare the profitability ratios computed in both the scenarios and based on application of user-defined constraints, the system identifies the optimal promotion-types amongst a plurality of applicable promotion-types. The optimal promotion-types indicates most suitable promotion-types for a particular product at particular location and time period.

This application claims the benefit of Indian Patent Application Serial No. 201741000235, filed Jan. 3, 2017, which is hereby incorporated by reference in its entirety.

### FIELD

The present disclosure relates in general to data analytics and in particularly to a method and system for identifying an optimal promotion-type for products.

### BACKGROUND

Products which are sold at retail stores, warehouses or distribution centers comes with an expiry date. The expiry date defines the maximum time-period up to which the product can be safely used or consumed. Thus, it becomes mandatory to sell the products well before their expiry date. However, many a times, it has been observed that retailers face huge loss due to the non-selling of the products before their expiry date. Thus, those expired products may be either recalled, recycled, destroyed, or sold at a lower cost.

To overcome this problem, or in other words, to promote the sale of the product, many promotional offers like discounts, buy one get one free, free coupons and the like are planned by the retailers. However, before planning and implementing such promotional offers, the challenge faced by the retailers is to realize an impact of promotional offers. The retailers must be aware about of consequences if any promotional offers are applied.

### SUMMARY

Disclosed herein is a method and system for identifying optimal promotion-type for plurality of products stored in an entity like retail store or distribution center. Promotions are not only applied for increasing sales of products, but it also helps in clearing those products whose expiry dates are approaching. In the present disclosure, various scenarios have been considered by the system which not only minimizes losses caused by product obsolescence, but it also helps in identifying a suitable promotion or a promotion-type for a particular product at a particular time and location.

Accordingly, the present disclosure relates to a method for identifying optimal promotion-types for products in an inventory list. The method comprises a step of computing, for each promotion-type of a plurality of promotion-types, a non-promotional profitable ratio (NPPR) and a promotional profitable ratio (PPR) relative to a current location of a product and pre-defined time intervals of a product trade cycle associated with the product. Further, the method comprises a step of identifying, for each current location and a corresponding pre-defined time interval associated with the product, one or more combination of ratios indicating the NPPR less than the PPR. The one or more combination of ratios satisfies a user-defined profit threshold factor. The method further comprises determining, for each of the current location and the corresponding pre-defined time interval associated with the product, optimal promotion-types based on application of user-defined constraint factors and user-defined priority data on the one or more combination of ratios.

Further, the present disclosure relates to a promotion-type identification system to identify optimal promotion-types for products in an inventory list. The promotion-type identification system comprises a processor and a memory communicatively coupled to the processor. The memory stores processor-executable instructions, which, on execution, causes the processor to perform one or more operations comprising computing, for each promotion-type of a plurality of promotion-types, a non-promotional profitable ratio (NPPR) and promotional profitable ratio (PPR) relative to a current location of a product and pre-defined time intervals of a product trade cycle associated with the product. Further, the system identifies, for each current location and a corresponding pre-defined time interval associated with the product, one or more combination of ratios indicating the NPPR less than the PPR. The one or more combination of ratios satisfies a user-defined priority threshold factor. Further, the system determines, for each of the current location and the corresponding pre-defined time interval associated with the product, optimal promotion-types based on application of user-defined constraint factors and user-defined priority data on the one or more combination of ratios.

Furthermore, the present disclosure relates to a non-transitory computer readable medium including instructions stored thereon that when processed by at least one processor cause a promotion-type identification system to perform the acts of computing, for each promotion-type of a plurality of promotion-types, a non-promotional profitability ratio (NPPR) and a promotion profitability ratio (PPR) relative to a current location of a product and pre-defined time intervals of a product trade cycle associated with the product. Further, the promotion-type identification system identifies, for each current location and a corresponding pre-defined time interval associated with the product, one or more combination of ratios indicating the NPPR less than the PPR. The one or more combination of ratios satisfies a user-defined priority threshold factor. The promotion-type indication system further determines, for each of the current location and the corresponding pre-defined time interval associated with the product, optimal promotion-types based on application of user-defined constraint factors and user-defined priority data on the one or more combination of ratios.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment illustrating a promotion-type identification system for identifying optimal promotion-types for a plurality of products in accordance with some embodiments of the present disclosure;

FIG. 2 shows a detailed block diagram illustrating the promotion-type identification system in accordance with some embodiments of the present disclosure;

FIG. 3 shows an example of identifying optimal promotion-types using NPPR and PPR in accordance with some embodiments of the present disclosure;

FIG. 4 shows a flowchart illustrating a method of identifying optimal promotion-types for plurality of products in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a promotion-type identification system (alternatively also referred as “system”) for identifying optimal promotion-types for plurality of products. Although, the method for identifying the optimal promotion-types is described in conjunction with a server, the said method can also be implemented in various computing systems/devices, other than the server. The plurality of products are those products which are available at entities like retail stores or distribution centers. As it is conventionally known that each product has an expiry date. Once the date is expired, the product may not be eligible for being sold which ultimately leads to financial loss.

Apart from the financial loss issue, another problem is wastage of the plurality of products due to non-selling in limited time-period. To address this, promotions or offers are devised by retailers or manufactures to keep a smooth flow of the selling of the products. However, before finalizing the promotions or a promotion, various factors needs to be taken care of In the present disclosure, the system considers the various factors like location, time, sales, losses and the like to finalize a promotion-type to be applied on a particular product, which is explained in detail in subsequent paragraphs of the specification. Thus, one of an objective of the present disclosure is to overcome the issue of product obsolescence and minimize the financial loss by identifying most appropriate promotion-type amongst the available promotion-types.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

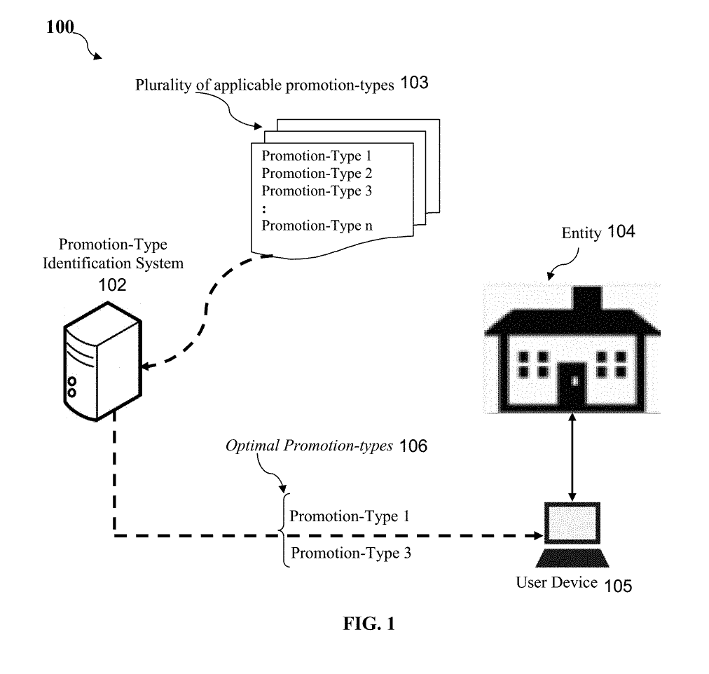

FIG. 1 shows an exemplary environment illustrating a promotion-type identification system for identifying an optimal promotion-type for a plurality of products.

The environment 100 comprises the promotion-type identification system 102, a plurality of applicable promotion-types 103 (Promotion-Type 1, Promotion-Type 2, Promotion-Type 3 Promotion-Type n), an entity 104, a user device 105, and optimal promotion-types 106. The entity 104 may be a retail store or distribution centre where the plurality of products is being sold. The entity 104 may be managed by retail managers or store managers (collectively referred as users) having a user device 105. The user device 105 may be communicatively coupled with the promotion-type identification system 102. Examples of the user device 105 may include a mobile device, a laptop, a desktop computer, or any computing device.

From the FIG. 1, it can be understood that amongst n number of promotion types, the promotion-type identification system 102 identifies a promotion-type 1 and a promotion-type 3 i.e., an optimal promotion-types. The identification of the optimal promotion-types is based on various factors which is later explained in detail. In an embodiment, the promotion-type identification system 102 may include, but not limited to, a server, a computer, a workstation, a laptop, mobile phone, or any computing system/device capable of receiving, analysing and processing the useful information.

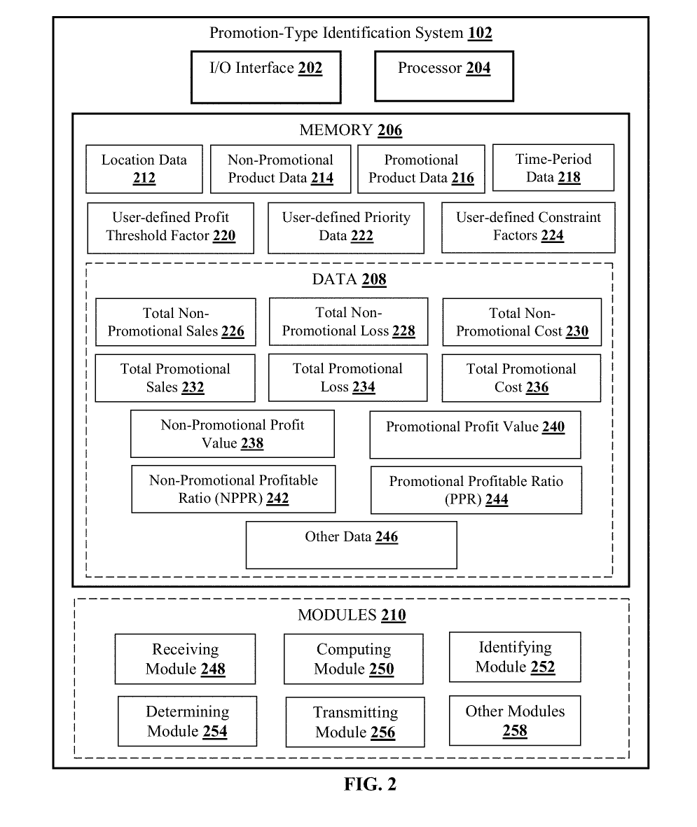

FIG. 2 shows a detailed block diagram illustrating the promotion-type identification system in accordance with some embodiments of the present disclosure.

The promotion-type identification system 102 comprises an I/O interface 202, a processor 204 and a memory 206. The memory 206 is communicatively coupled to the processor 204. The processor 204 is configured to perform one or more functions of the promotion-type identification system 102 for identifying optimal promotion-types. In one implementation, the promotion-type identification system 102 comprises data 208 and modules 210 for performing various operations in accordance with the embodiments of the present disclosure. The memory 206 further comprises location data 212, non-promotional product data 214, promotional product data 216, time-period data 218, user-defined profit threshold factor 220, user-defined priority data 222 and user-defined constraint factors 224. In an embodiment, the data 208 may include, without limitation, total non-promotional sales 226, total non-promotional loss 228, total non-promotional cost 230, total promotional sales 232, total promotional loss 234 and total promotional cost 236, non-promotional profit value 238, promotional profit value 240, non-promotional profitable ratio (NPPR) 242, promotional profitable ratio (PPR) 244 and other data 246.

In one embodiment, the data 208 may be stored within the memory 206 in the form of various data structures. Additionally, the aforementioned data 208 can be organized using data models, such as relational or hierarchical data models. The other data 246 may store data, including temporary data and temporary files, generated by modules 210 for performing the various functions of the promotion-type identification system 102.

In an embodiment, the data 208 may be processed by one or more modules 210. In one implementation, the one or more modules 210 may also be stored as a part of the processor 204. In an example, the one or more modules 210 may be communicatively coupled to the processor 204 for performing one or more functions of the promotion-type identification system 102.

In one implementation, the one or more modules 210 may include, without limitation, a receiving module 248, a computing module 250, an identifying module 252, a determining module 254, a transmitting module 256, and other modules 258. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In an embodiment, the computing module 250 may compute, for each promotion-type of a plurality of promotion-types, non-promotional profitable ratio (NPPR) 242 and promotional profitable ratio (PPR) 244. The NPPR 242 and the PPR 244 is computed relative to a current location of a product and pre-defined time intervals of a product trade cycle associated with the product, which is explained here in detail.

According to an embodiment, the receiving module 244 may receive various data to ensure that possible factors for identifying optimal (or most suitable) promotion-types must be considered. As discussed earlier that the objective of present disclosure is to overcome the product obsolescence issue by identifying the optimal promotion-types for the plurality of products. In order to achieve the aforesaid objective, in first step, the receiving module 244 of the system 102 may receive location data 212, non-promotional product data 214 and promotional product data 216 related to the plurality of products, time-period data 218, user-defined profit threshold factor 220, user-defined priority data 222 and user-defined constraint factors 224. It can be observed that the system 102 receives the data from different perspectives. For example, the location data 212 comprises location of the plurality of products in an entity 104. In other words, the location data 212 may indicate the place where the plurality of products are currently available, for example, a retail store, a distribution center, or a warehouse.

Further, another perspective which is considered by the system 102 is non-promotional scenario and promotional scenario. At any particular time, the plurality of products can be sold at a discounted rate or under any promotion applied e.g., buy 1 get 1 free (i.e., promotional scenario) or without any discount or promotion (i.e., non-promotional scenario). Hence, the consideration of both the scenarios are important, because it helps the system 102 to understand impact of sales, loss, and cost on the plurality of products when the promotion is applied and when the promotion is not applied.

For example, in the non-promotional scenario, the non-promotional product data 214 may include data like non-promotional price (NPR) which indicates the price of the plurality of products when no promotion is applied, a non-promotional demand (NPD) which indicates forecasted demand of the plurality of products during non-promotional period, cost price (C) and salvage value (E) of the plurality of products.

Similarly, in the promotional scenario, the promotional product data 216 may include data like promotional price (PR) which indicates the price of the plurality of products when the promotion is applied, a promotional demand (PD) which indicates forecasted demand of the plurality of products during promotional period, cost of promotion per unit (PC) associated with the plurality of products, the cost price (C) and the salvage value (E) of the plurality of products.

Apart from the non-promotional product data 214 and promotional product data 216, another perspective considered by the system 102 is the time-period data 218 which indicates number of days for executing one or more promotions or a number of days when no promotion is applied on the plurality of products. Yet another perspective considered is user's perspective i.e., user-defined profit threshold factor 220, the user-defined priority data 222, and user-defined constraint factors 224 received by the user. The user-defined constraint factors 224 may include a plurality of applicable promotion-types which may be applied on the plurality of products and a total budget available for the plurality of applicable promotion-types.

Upon receiving the above mentioned data (212, 214, 216, 218, 220, 222, and 224), the system 102 may now compute various values for both the scenarios i.e., non-promotional and promotional scenario. For example, according to an embodiment of present disclosure, the computing module 250 of the system 102 may compute total non-promotional sales 226, total non-promotional loss 228 and total non-promotional cost 230, non-promotional profit value 238 and non-promotional profitable ratio (NPPR) 242 for the plurality of products in the non-promotional scenario. Similarly, according to another embodiment of present disclosure, the computing module 252 of the system 102 may compute total promotional sales 232, total promotional loss 234, total promotional cost 236, promotional profit value 240 and promotional profitable ratio (PPR) 244 for the plurality of products in the promotional scenario. Computation of each of the above values in both the scenarios is explained here in detail.

### Computation in Non-Promotional Scenario

The total non-promotional sales 226 denoted by TSᵢⱼₜ is computed for i^{th} product, j^{th} location and for a time period starting from “t” for “v” number of days. The computation of TSᵢⱼₜ is represented by:

TSᵢⱼₜ=NPRᵢⱼₜ×NPDᵢⱼₜ

Where, the NPR indicates the non-promotional price for the i^{th} product and NPD indicates the forecasted demand for the i^{th} product (of the plurality of products) during the non-promotional period starting from t for v number of days. According to an embodiment of present disclosure, the NPD may be calculated by trend analysis using linear regression of the demand for the same period considering actual sales data for predefined previous years (e.g., past 15 years). The actual sales data or past sales data may be stored in the system 102. Now, once the total non-promotional sales 226 for the i^{th} product is computed, the computing module 250 may further compute the total non-promotional sales 226 across all the locations and for all the products (i.e., the plurality of products) for a particular time period, which is represented as:

TSₜ=Σᵢ₌₁ⁿΣⱼ₌₁^{m}NPRᵢⱼ×NPDᵢⱼ, where t=1 . . . R

Next, the total non-promotional loss 228 (denoted by LOᵢⱼₜ) due to the obsolescence is computed for i^{th} product, j^{th} location and time period “t”. The computation is represented as:

$${LO}_{ijt} = ( {\sum }_{t = t}^{v} {E}_{ijt} ) \times ( {C}_{ijt} - {S}_{ijt} )$$

Where, C represents the cost price and S represents the salvage value of a product. Further, E indicates the actual number of products expiring on each day for a particular product (of the plurality of products) at a particular location. The value of E can be determined by:

Eᵢⱼₜ=NPDᵢⱼₜ−Oᵢⱼₜ−Eᵢⱼₜ₍ₜ₋₁₎. Consider only If Eᵢⱼₜ₋₁<0, consider absolute value Eᵢⱼₜ=0, if Eᵢⱼₜ<0

Whereas, “O” represents the number of products by location which have the expiry date on a particular date. Now, once the total non-promotional loss 228 for the i^{th} product is computed, the computing module 250 of the system 102 may further compute the total non-promotional loss 228 across all the products (i.e., the plurality of products) and all the locations for a particular time period which is represented as:

T0ₜ=Σₜ₌₁ⁿΣⱼ₌₁ⁿ(Σₜ₌ₜ^{y}Eᵢⱼₜ)×(Cᵢⱼ−Sᵢⱼ), where t=1 . . . R

Next, the total non-promotional cost 230 (denoted by TCᵢⱼₜ) is computed for the i^{th} product, j^{th} location and time period t, which is represented as:

TCᵢⱼₜNPDᵢⱼₜ×Cᵢⱼₜ

Where, the NPD indicates the forecasted demand for the i^{th} product (of the plurality of products) during the non-promotion period and C represents the cost price. Once the total non-promotional cost 230 for the i^{th} product is computed, the computing module 250 may further compute the total non-promotional cost 230 across all the products (i.e., the plurality of products) and all the locations for a particular time period which is represented as:

TCₜ=Σₜ₌₁ⁿΣⱼ₌₁^{m}Cᵢⱼ×NPDᵢⱼ, where t=1,2 . . . n

After computing the total non-promotional sales (TSᵢⱼₜ) 226, the total non-promotional loss (LOᵢⱼₜ) 228 and the total non-promotional cost (TCᵢⱼₜ) 230, the computing module 250 of the system 102 may now compute non-promotional profit value (TPᵢⱼₜ) 238 based on TSᵢⱼₜ 226, LOᵢⱼₜ 228 and TCᵢⱼₜ 230. The computation of the non-promotional profit value (TPᵢⱼₜ) 238 for i^{th} product, j^{th} location and time period t is represented by:

TPᵢⱼₜ=TSᵢⱼₜ−L0ᵢⱼₜ−TCᵢⱼₜ

Based on the non-promotional profit value (TPᵢⱼₜ) 238 computed and the total non-promotional sales (TSᵢⱼₜ) 226, the computing module 250 of the system 102 may finally compute a non-promotional profitable ratio (NPPR) 242. The computation of the non-promotional profitable ratio (NPPR) 242 is represented as:

NPPRᵢⱼₜ=TPᵢⱼₜ/TSᵢⱼₜ

### Computation in Promotional Scenario

The total promotional sales 232 denoted by PSᵢⱼₜ is computed for i^{th} product, j^{th} location, q^{th} promotion-type (of the plurality of applicable promotion-types 103) and for a time period starting from “t” for “v” number of days. The computation of PSᵢⱼₜ is represented by:

PS_{ijtq}=(P R_{ijtq}−PC_{ijtq})×PD_{ijtq}

Where, the PR indicates the promotional price and PD indicates the forecasted promotional demand for the i^{th} product (of the plurality of products) during the promotion period starting from t for v number of days. According to an embodiment of the present disclosure, the PD may be calculated by trend analysis using linear regression of the promotional demand for the same period and promotion-type considering actual sales data for predefined previous years (e.g., past 15 years). The actual sales data or past sales data may be stored in the system 102. Further, the PC indicates the cost of promotion per unit associated with the i^{th} product. Now, once the total promotional sales 232 for the i^{th} product is computed, the computing module 250 may further compute the total promotional sales 232 across all the locations and for all the products (i.e., the plurality of products) for a particular time period and the promotion-type. The computation is represented as:

PS_{tq}=Σⱼ₌₁ⁿΣⱼ₌₁^{m}(PRᵢⱼ−PCᵢⱼ)×PDᵢⱼ, where t=1 . . . r, q=1 . . . k

Next, the total promotional loss 234 (denoted by LP_{ijtq}) due to the obsolescence is computed for i^{th} product, j^{th} location, q^{th} promotion type and time period “t”. The computation is represented as:

$${LP}_{ijtq} = ( {\sum }_{t = t}^{v} {E}_{ijqt} ) \times ( {C}_{ijt} - {S}_{ijt} )$$

Where, C represents the cost price and S represents the salvage value of a product. Further, EP indicates the actual number of products expiring on each day for a particular product (of the plurality of products) at a particular location. The value of EP can be determined by:

EPᵢⱼₜ=PDᵢⱼₜ−Oᵢⱼₜ−EPᵢⱼ₍ₜ₋₁₎, Consider only If EPᵢⱼₜ₋₁<0, consider absolute value EPᵢⱼₜ=0, if EPᵢⱼₜ<0

Whereas, “O” represents the number of products by location which have the expiry date on a particular date. Now, once the total promotional loss 234 for the i^{th} product and q^{th} promotion type is computed, the computing module 250 of the system 102 may further compute the total promotional loss 234 across all the products (i.e., the plurality of products) and all the locations for a particular time period and the promotion-type. The computation is represented as:

LP_{tq}=Σᵢ₌₁ⁿΣⱼ₌₁^{m}(Σₜ₌ₜ^{y}EPᵢⱼₜ)×(Cᵢⱼ−Sᵢⱼ), where t=1 . . . R, q=1 . . .

Next, the total promotional cost 236 (denoted by PCᵢⱼₜ) is computed for the i^{th} product, j^{th} location, q^{th} promotion-type and for the time period t, which is represented as:

PCᵢⱼₜ=PDᵢⱼₜ×Cᵢⱼₜ

Where, the PD indicates the forecasted promotional demand for the i^{th} product (of the plurality of products) during the promotion period and C represents the cost price. Once the total promotional cost 236 for the i^{th} product is computed, the computing module 250 may further compute the total promotional cost 236 across all the products (i.e., the plurality of products), across all the locations and across all the promotion-type for a particular time period which may be represented as:

PC _{tq}=Σᵢ₌₁ⁿΣⱼ₌₁^{m}Cᵢⱼ×PDᵢⱼ, where t=1,2 . . . n, q=1 . . . k

After computing the total promotional sales (PS_{ijtq}) 232, total promotional loss (LP_{ijtq}) 234 and total promotional cost (PCᵢⱼₜ) 236, the computing module 250 of the system 102 may now compute promotional profit value (PP_{ijtq}) 240 based on PS_{ijtq} 232, LP_{ijtq} 234 and PCᵢⱼₜ 236. The computing of the promotional profit value (PP_{ijtq}) 240 for i^{th} product, j^{th} location, q^{th} promotion-type and time period t is represented as:

PP_{ijtq}=PS_{ijtq}−LP_{ijtq}−PCᵢⱼₜ

Based on the promotional profit value (PP_{ijtq}) 240 computed and the total promotional sales (PS_{ijtq}) 232, the computing module 250 of the system 102 may finally compute a promotional profitable ratio (PPR) 244. The computation of the promotional profitable ratio (PPR) 244 is represented as:

PPR_{ijtq}=PP_{ijtq}/TS_{ijtq}

The computation of the NPPR 242 and the PPR 244 helps the system 102 to understand an overall impact caused due to sales/profit/loss on the plurality of products in the non-promotional scenario and promotional scenario. To understand the overall impact, let's refer the below table 1.

TABLE 1
Overall impact based on the NPPR and the PPR values.

| Conditions | Impact |
|---|---|
| NPPR > PPR | Running promotion-type q for product i in location j at |
| | time period t is “NOT PROFITABLE” |
| NPPR < PPR | Running promotion type q for product i in location j at |
| | time period t is “PROFITABLE” |
| PPR − NPPR > 0 | Apply user-defined priority data |

Thus, from the above table 1, it can be observed that if the value of NPPR 242 is greater than the value of the PPR 244, it may be determined that the promotion-type currently being applied is not profitable. However, now if the PPR 244 is greater than the NPPR 242 i.e., second condition, it may be determined that the promotion-type currently being applied is profitable. Now, as per third condition, if the difference between the PPR 244 and the NPPR 242 is greater than zero (0), then the system 102 may apply the user-defined priority data 222. Further, the system 102 may compute a final profitability ratio by using:

FPR_{ijtq}=αᵢ×βⱼ×γₜ×δ_{q}×(PPR_{ijtq}−NPPR_{ijtq})

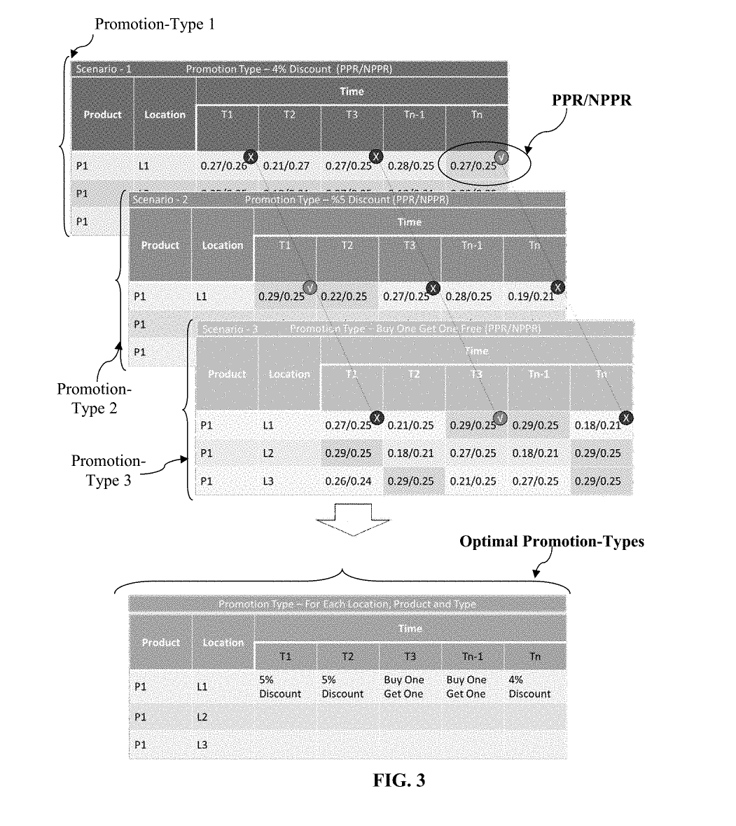

Now, the system 102 uses the computed values i.e., NPPR 242 and the PPR 244 for identifying an optimal promotion-type, which is explained below with help of FIG. 3.

FIG. 3 shows an example of identifying optimal promotion-types using NPPR and PPR in accordance with some embodiments of the present disclosure.

The values of the PPR 244 and NPPR 242 computed corresponding to a product, time, location and promotion-type can be observed from the three tables shown in FIG. 3. Each table represents a promotion-type. For example, the first table (i.e., topmost table) represents a promotion-type 1 (i.e., 4% discount) along with the values of PPR 244 and NPPR 242. Similarly, the second table (middle table) represents a promotion-type 2 (i.e., 5% discount) along with the values of PPR 244 and NPPR 242. Similarly, the third table represents a promotion-type 3 (i.e., buy one get one free) along with the values of PPR 244 and NPPR 242.

By using the above discussed tables and their values of the PPR 244 and the NPPR 242, the identifying module 252 of the system 102 may identify optimal promotion-types for each current location and a corresponding pre-defined time interval associated with the product. At first, the identifying module 252 may determine a difference between the PPR 244 and NPPR 242 (i.e., PPR−NPPR) corresponding to each table. Upon determining the difference, in next step, the identifying module 252 may identify or select all those combination of ratios (i.e., PPR/NPPR as shown in FIG. 3) indicating the NPPR 242 less than the PPR 244. Thereafter, the identified combination of ratios is sorted in a descending order. Post sorting, the identifying module 252 may also verify whether the combination of ratios satisfies the user-defined profit threshold factor 220. The user may set the profit threshold factor 220 such that only when the PPR 244 is greater than the NPPR 242 by x %, the combination of ratios (PPR/NPPR) will be selected. For example, if the user selects 5% as the profit threshold factor 220, then the identifying module 252 selects only those combinations of ratios of PPR/NPPR in which following condition is met:

PPR−NPPR/NPPR*100>5

Now, Amongst the sorted combination of ratios, the determining module 254 may select, a combination of ratio having maximum value, for each time-period T.

For example, the maximum value of PPR−NPPR for time-period “T1” is (0.29−0.25=0.04). The value “0.04” falls under the promotion-type 2 i.e., 5% discount. Similarly, the maximum value of PPR−NPPR for time “T2” is (0.22−0.25=−0.03). Although, the value comes in negative, but it is still higher than other two values of PPR−NPPR for the time “T2”. The value “−0.03” falls under the promotion-type 2 i.e., 5% discount. Further, the maximum value of PPR−NPPR for time “Tn” is (0.27−0.25=0.02). The value “0.02” falls under the promotion-type 1 i.e., 4% discount. In yet another example, the maximum value of PPR−NPPR for time “Tn−1” is (0.29−0.25=0.04). The value “0.04” falls under the promotion-type 3 i.e., buy one get one free. Post selecting the combination of ratios having the maximum value, the determining module 254 may further apply the user-defined constraint factors 224 and user-defined priority data 222 on the combination of ratios selected. According to embodiments, the user-defined constraint factors 224 may comprise a plurality of applicable promotion-types and a total budget available for the plurality of applicable promotion types. The application of the user-defined constraint factors 224 is explained below:

u≤M 1

B≥Σₛ₌₁^{u}PCₛ×PDₜ 2

The above 2 conditions (1 & 2) indicates the user-defined constraints, for example “B” is the total budget available and “M” is the plurality of applicable promotions. The above conditions states that final number of selected promotions (u) should be less than M (i.e., plurality of applicable promotions), and the total promotional cost 236 for the selected promotions should not exceed the total budget B. Further, the system 102 iteratively calculate the best possible combination satisfying the above constraints which will maximize Σₛ₌₁^{u}(PPₜ−TPₛ)

Thus, based on the above computation of PPR−NPPR and the application of the user-defined constraint factors 224 and user-defined priority data 222, the determining module 254 of the system 102 may determine the optimal promotion-types shown in the bottom-most table of FIG. 3. This table clearly shows the combination of optimal promotion-types for each pre-defined time-interval or time-period (i.e., T1 to Tn) corresponding to each combination of products and locations. This way the optimal promotion-types are determined, for each of the current location and the corresponding pre-defined time interval associated with the product, amongst the plurality of applicable promotion-types applicable. Once the optimal promotion-types are identified, the transmitting module 256 of the system 102 may transmit the optimal promotion-types to the user device 105 of a user associated with the entity 104.

As an example, for the product P1 at location L1 and time period T1, the optimal promotion type applicable is 5% discount.

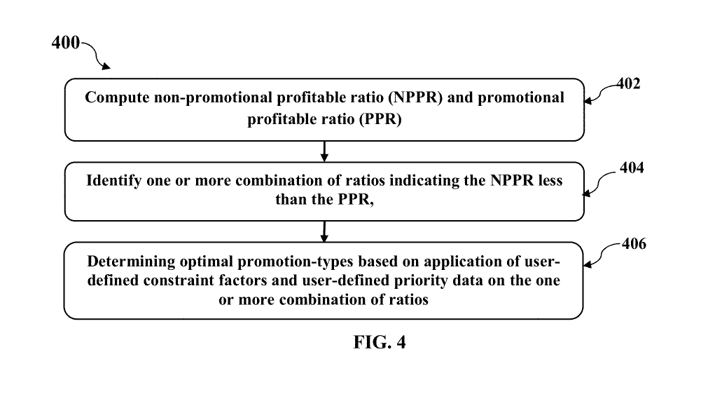

FIG. 4 shows a flowchart illustrating a method for identifying an optimal promotion-type for a plurality of products with some embodiments of the present disclosure.

As illustrated in FIG. 4, the method 400 comprises one or more blocks for identifying an optimal promotion-types for a plurality of products using a promotion-type identification system 102. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 402, the promotion-type identification system 102 may compute, for each promotion-type of a plurality of promotion-types, non-promotional profitable ratio (NPPR) and promotional profitable ratio (PPR) relative to a current location of a product and pre-defined time intervals of a product trade cycle associated with the product.

At block 404, the promotion-type identification system 102 may identify, for each current location and a corresponding pre-defined time interval associated with the product, one or more combination of ratios indicating the NPPR less than the PPR. The one or more combination of ratios satisfies a user-defined profit threshold factor.

At block 406, the promotion-type identification system 102 may determine, for each of the current location and the corresponding pre-defined time interval associated with the product, optimal promotion-types based on application of user-defined constraint factors and user-defined priority data on the one or more combination of ratios.

### Computer System

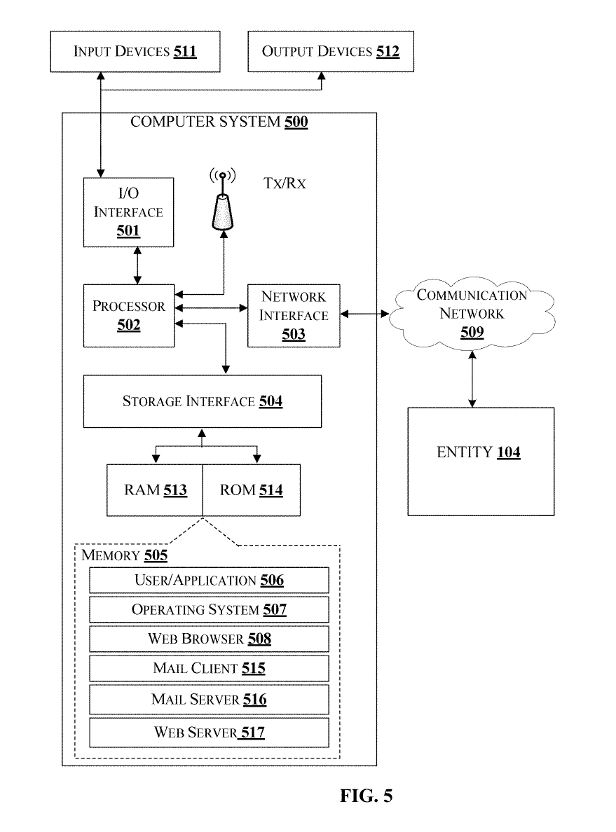

FIG. 5 illustrates a block diagram of an exemplary computer system 500 for implementing embodiments consistent with the present invention. In an embodiment, the computer system 500 can be the promotion-type identification system 102 which is used for identifying an optimal promotion-type for a plurality of products. The computer system 500 may comprise a central processing unit (“CPU” or “processor”) 502. The processor 502 may comprise at least one data processor for executing program components for executing user- or system-generated business processes. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 501, the computer system 500 may communicate with one or more I/O devices (511 and 512).

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network 509 can be implemented as one of the different types of networks, such as intranet or Local Area Network (LAN) and such within the organization. The communication network 509 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc.

In some embodiments, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application data 506, an operating system 507, web browser 508 etc. In some embodiments, computer system 500 may store user/application data 506, such as the data, variables, records, etc. as described in this invention. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. I/O interface 501 may facilitate display, execution, interaction, manipulation, or operation of program components through textual or graphical facilities. For example, I/O interface may provide computer interaction interface elements on a display system operatively connected to the computer system 500, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 500 may implement a web browser 508 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 500 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein

In an embodiment, the present disclosure provides a method for efficiently identifying most suitable promotion-type to be applied on the plurality of products.

In an embodiment, the present disclosure provides a method for minimizing the losses caused due to product obsolescence.

In an embodiment, the present disclosure provides a method for minimizing the wastage of the products due to non-selling in limited time-period.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for identifying optimal promotion-types for products in an inventory list, the method comprising:
computing, by a promotion-type identification computing device and for each promotion-type of a plurality of promotion-types, a non-promotional profitability ratio (NPPR) and a promotion profitability ratio (PPR) relative to a current location of a product and one or more pre-defined time intervals of a product trade cycle associated with the product;
identifying, by the promotion-type identification computing device and for each current location and corresponding pre-defined time intervals associated with the product, one or more combination of ratios indicating the NPPR less than the PPR, wherein the one or more combination of ratios satisfies a user-defined profit threshold factor; and
determining, by the promotion-type identification computing device and for each current location and corresponding pre-defined time intervals associated with the product, one or more optimal promotion-types based on application of user-defined constraint factors and user-defined priority data on the one or more combination of ratios.

2. The method as claimed in claim 1, wherein the computing further comprises:
receiving, by the promotion-type identification computing device, location data comprising another current location of a plurality of products in an entity, non-promotional product data and promotional product data related to the plurality of products, time-period data, and the user-defined constraint factors comprising a plurality of applicable promotion-types and a total budget available for the plurality of applicable promotion-types; and
computing, by promotion-type identification computing device, total non-promotional sales, total non-promotional loss and total non-promotional cost for the plurality of products based on the location data, the non-promotional product data and the time-period data, and total promotional sales, total promotional loss and total promotional cost for the plurality of products based on the location data, the promotional product data and the time-period data, non-promotional profit value based on the total non-promotional sales, the total non-promotional loss and the total non-promotional cost and promotional profit value based on the total promotional sales, the total promotional loss and the total promotional cost, wherein the NPPR is based on the non-promotional profit value and the total non-promotional sales, and the promotional profitable ratio (PPR) is based on the promotional profit value and the total promotional sales.

3. The method as claimed in claim 2, further comprising transmitting, by promotion-type identification computing device, the optimal promotion types to a user device of a user associated with the entity.

4. The method as claimed in claim 2, wherein the time-period data comprises a number of days for executing one or more promotions or non-promotions on the plurality of products.

5. The method as claimed in claim 2, wherein the entity comprises at least one of a manufacturing store, a retail store, or an inventory.

6. A promotion-type identification computing device, comprising:
a processor; and
a memory communicatively coupled to the processor, wherein the memory comprises processor-executable instructions stored thereon, which, on execution by the processor, causes the processor to:
compute, for each promotion-type of a plurality of promotion-types, a non-promotional profitability ratio (NPPR) and a promotion profitability ratio (PPR) relative to a current location of a product and one or more pre-defined time intervals of a product trade cycle associated with the product;
identify, for each current location and corresponding pre-defined time intervals associated with the product, one or more combination of ratios indicating the NPPR less than the PPR, wherein the one or more combination of ratios satisfies a user-defined profit threshold factor; and
determine, for each current location and corresponding pre-defined time intervals associated with the product, one or more optimal promotion-types based on application of user-defined constraint factors and user-defined priority data on the one or more combination of ratios.

7. The promotion-type identification computing device as claimed in claim 6, wherein the processor-executable instructions, when executed by the processor, further cause the processor to:
receive location data comprising another current location of a plurality of products in an entity, non-promotional product data and promotional product data related to the plurality of products, time-period data, and the user-defined constraint factors comprising a plurality of applicable promotion-types and a total budget available for the plurality of applicable promotion-types; and
compute total non-promotional sales, total non-promotional loss and total non-promotional cost for the plurality of products based on the location data, the non-promotional product data and the time-period data, and total promotional sales, total promotional loss and total promotional cost for the plurality of products based on the location data, the promotional product data and the time-period data, non-promotional profit value based on the total non-promotional sales, the total non-promotional loss and the total non-promotional cost and promotional profit value based on the total promotional sales, the total promotional loss and the total promotional cost, wherein the NPPR is based on the non-promotional profit value and the total non-promotional sales, and the promotional profitable ratio (PPR) is based on the promotional profit value and the total promotional sales.

8. The promotion-type identification computing device as claimed in claim 7, wherein the processor-executable instructions, when executed by the processor, further cause the processor to transmit the optimal promotion types to a user device of an user associated with the entity.

9. The promotion-type identification computing device as claimed in claim 7, wherein the time-period data comprises a number of days for executing one or more promotions or non-promotions on the plurality of products.

10. The promotion-type identification computing device as claimed in claim 7, wherein the entity comprises at least one of a manufacturing store, a retail store, or an inventory.

11. A non-transitory computer-readable storage medium comprising instructions stored thereon that when processed by at least one processor cause the at least one processor to perform operations comprising:
computing, for each promotion-type of a plurality of promotion-types, a non-promotional profitability ratio (NPPR) and a promotion profitability ratio (PPR) relative to a current location of a product and one or more pre-defined time intervals of a product trade cycle associated with the product;
identifying, for each current location and corresponding pre-defined time intervals associated with the product, one or more combination of ratios indicating the NPPR less than the PPR, wherein the one or more combination of ratios satisfies a user-defined profit threshold factor; and
determining, for each current location and corresponding pre-defined time intervals associated with the product, one or more optimal promotion-types based on application of user-defined constraint factors and user-defined priority data on the one or more combination of ratios.

12. The medium as claimed in claim 11, wherein the instructions further cause the at least processor to perform one or more additional operations comprising:
receiving location data comprising another current location of a plurality of products in an entity, non-promotional product data and promotional product data related to the plurality of products, time-period data, and the user-defined constraint factors comprising a plurality of applicable promotion-types and a total budget available for the plurality of applicable promotion-types; and
computing total non-promotional sales, total non-promotional loss and total non-promotional cost for the plurality of products based on the location data, the non-promotional product data and the time-period data, and total promotional sales, total promotional loss and total promotional cost for the plurality of products based on the location data, the promotional product data and the time-period data, non-promotional profit value based on the total non-promotional sales, the total non-promotional loss and the total non-promotional cost and promotional profit value based on the total promotional sales, the total promotional loss and the total promotional cost, wherein the NPPR is based on the non-promotional profit value and the total non-promotional sales, and the promotional profitable ratio (PPR) is based on the promotional profit value and the total promotional sales.

13. The medium as claimed in claim 12, wherein the instructions further cause the at least processor to perform one or more additional operations comprising transmitting the optimal promotion types to a user device of a user associated with the entity.

14. The medium as claimed in claim 12, wherein the time-period data comprises a number of days for executing one or more promotions or non-promotions on the plurality of products.

15. The medium as claimed in claim 12, wherein the entity comprises at least one of a manufacturing store, a retail store, or an inventory.
